(19) United States
(12) Patent Application Publication
(10) Pub. No.: US 2007/0226020 A1
(43) Pub. Date: Sep. 27, 2007

(54) Systems and Methods for Pre-Computing Price or Availability of a Resource

(76) Inventor: Song Kyu Park, Greenwich, CT (US)

Correspondence Address: BAKER BOTTS L.L.P., 30 ROCKEFELLER PLAZA, 44TH FLOOR, NEW YORK, NY, 10112-4498, US

(21) Appl. No.: 11/615,613

(22) Filed: Dec. 22, 2006

Related U.S. Application Data
(60) Provisional application No. 60/753,475, filed on Dec. 22, 2005.

(51) Int. Cl. G06Q 10/00

(52) U.S. Cl. 705/5

(57) ABSTRACT

Methods for checking for the availability of a rental resource by providing a pre-computed availability data set for at least one rental resource including an availability data entry for each of a plurality of rental periods beginning on each of a plurality of start times and extending for each of a plurality of time units, receiving a rental resource availability request including at least a desired rental period which has a start time and an end time, querying the pre-computed availability data set for the desired rental period, determining, based on the querying, whether or not a rental resource is available for the rental period, and returning a positive response when a rental resource is available for the desired rental period.

### BACKGROUND OF THE INVENTION

This application claims priority to U.S. provisional application 60/753,475, filed on Dec. 22, 2005, and entitled “Techniques for Pre-Computing Price or Availability of a Resource,” which is hereby incorporated by reference.

Many industries are based on the concept of temporarily allocating a product or service to a customer for a fee. Examples include the hotel, rental car, airline, and service industries. One common task of businesses in these industries is the ability to store and provide data about the availability and price of a particular product for a particular time. However, while this availability and price data is stored in a “raw” format, it must be produced in a more “complex” format upon request.

Availability data, for instance, is typically stored in a basic inventory model consisting of the number of total resources and the number of resources available for each individual time unit. Time units can be days, hours, or any other measure of time. However, the “complex” availability, or actual availability of the rental resource, is often based not just on the basic inventory. For example, availability in the hotel industry can be based on not only whether the rental resource is available over a certain number of time units, but on a multitude of other factors such as yield management rules, selling rules as to the preferred room to be sold first, overbooking allowances and administrator controlled status of the whole hotel itself, price categories, or even the individual room. As such, every time a customer requests the availability of a resource, some of these rules can be applied to the basic inventory to determine the complex or actual availability of the product. The large calculation that must be performed when a customer inquiry is made results in slow system response times for inquiries and also inhibits the scalability of the system.

Similarly, pricing information for most reservation systems is stored in an aggregate data structure of Rate Plans. Each Rate Plan has, and in most systems is stored with, a Name, ID, permissibility rules, and prices. In the hotel industry, the permissibility rules can be based on such things as what day of the week a guest can arrive to use a rate plan, what days of the week a guest must stay, what days of the week a guest can not stay, during which date range a Rate Plan can be sold, how many days in advance a booking must be made to use a Rate Plan, etc. There are many rules around when a specific Rate Plan can be used, and if the criteria of the customer's request satisfies the constraints of the rules around a given Rate Plan, the prices in that Rate Plan are permitted for sale. In the hotel industry, a single hotel can have thousands of rate plans, and a company can have hundreds of thousands of rate plans system wide across all the company's hotels. Moreover, any of those rate plans can meet the criteria that a customer requests. In most systems, the logic to determine whether a Rate Plan is available occurs at the time of request. As in the availability context, this results in slow system response times for inquiries and also inhibits the scalability of the system.

### BRIEF SUMMARY OF THE INVENTION

Systems and methods of pre-computation of availability and pricing data are disclosed herein.

In some embodiments, methods for checking for the availability of a rental resource include providing a pre-computed availability data set for at least one rental resource including an availability data entry for each of a plurality of rental periods beginning on each of a plurality of start times and extending for each of a plurality of time units, receiving a rental resource availability request including at least a desired rental period which has a start time and an end time, querying the pre-computed availability data set for the desired rental period, determining, based on the querying, whether or not a rental resource is available for the rental period, and returning a positive response when a rental resource is available for the desired rental period.

In other embodiments, this method for checking for the availability of a rental resource also includes a rental resource data set which has a collection of one or more rental resource data entries that represent individual, or even groups of, rental resources. The rental resource data entries in the rental resource data set can reference, or point to, any availability data entries in the pre-computed availability data set corresponding to a rental period for which the rental resource is available. Further, other embodiments use this rental resource data set to determine the availability of a rental resource or group of rental resources by checking for whether the rental resource data entry corresponding to the rental resource or group of rental resources references, or points to, the availability data entry corresponding to the time rental period included in the rental resource availability request. If the rental resource data entry does reference, or point to, that availability data entry, then it is available for that rental period, otherwise it is not. In other embodiments, the rental resource data entries are referenced, or pointed to, by the availability data entries in the pre-computed availability data set when those resources or groups of resources are available for the rental period corresponding to the referencing, or pointing, availability data entry. In this embodiment, and others like it, availability for a rental period can be checked by querying the availability data entry corresponding to that rental period and determining whether it references any rental resource data entries, which would indicate availability. In some embodiments, the method for checking the availability of a rental resource returns not just a positive or negative response, but an indication of at least one of the rental resources that is available.

In other embodiments, a method for checking for the availability of a rental resource provides a pre-computed availability data set containing an availability data entry for each rental resource, or group of rental resources, for each of a plurality of rental periods beginning on each of a plurality of start times and extending for each of a plurality of time units.

In other embodiments, a method for checking for the availability of a rental resource provides a pre-computed availability data set containing an availability data entry, including a price, for each rental resource, or group of rental resources, for each of a plurality of rental periods beginning on each of a plurality of start times and extending for each of a plurality of time units.

In a further embodiment, the time units are nights. In yet other embodiments, the rental resource can be a hotel room or an appointment with a service provider.

In some embodiments, methods for checking the price of a rental resource include providing a rate plan data set including a plurality of rate plans and a pre-computed pricing memory area, computing and storing in the pre-computed pricing memory area at least one pricing data entry including at least one price based on at least one of the rate plans for at least one rental resource for each of a plurality of rental periods beginning on each of a plurality of start times and extending for each of a plurality of time units, receiving a rental resource price request which contains at least one desired rental period made up of a start time and an end time, querying the pre-computed pricing memory area for the pricing data entry associated with the desired rental period, and returning at least one price corresponding to at least one rental resource for the desired rental period.

In other embodiments of these methods for checking the price of a rental resource, the lowest price is returned. In yet other embodiments, more than one price is returned. In some embodiments, the qualification state of the requesting entity is received and the lowest price that the requesting entity is qualified to receive is returned.

In other embodiments of these methods for checking the price of a rental resource, the rate plan data set includes a price or logic to determine a price based on at least one factor such as the start time of the desired rental period, the day of the week on which the desired rental period would begin, the days of the week that would be spanned by the desired rental period, the time that the rental resource price request is received, the identity of the person or system making the rental resource price request, and the amount of time between making the rental resource price request and the desired rental period.

In other embodiments, these methods for checking the price of a rental resource also include a rental resource data set which has a collection of one or more rental resource data entries that represent individual, or even groups of, rental resources. Each of these rental resource data entries reference, or point to, any pricing data entries corresponding to prices at which the rental resource, or group of rental resources, can permissibly be rented. Further, other embodiments use this rental resource data set to determine the permissible prices of a rental resource, or group of rental resources, by determining which pricing data entries that the rental resource data entry corresponding to the rental resource, or group of rental resources, references. In some embodiments, one price corresponding to a permissible pricing data entry referenced by the rental resource data entry is returned, while in other embodiments, the lowest permissible price or a plurality of permissible prices are returned.

In a further embodiment, the time units are nights. In yet other embodiments, the rental resource can be a hotel room or an appointment with a service provider.

In further embodiments, the pricing data set includes pricing data groups which can contain more than one pricing data entry. In this embodiment with pricing data groups, a rental resource data entry can reference a single pricing data group to indicate that the price of the rental resource corresponding with that rental resource data entry can be either all or only one of the prices associated with a pricing data entry contained in the pricing data group.

In other embodiments, all of these methods for checking for the availability or price of a rental resource can be carried out by a system which includes a computer readable medium having a set of instructions operable to direct a processor to perform the steps of the methods.

### BRIEF DESCRIPTION OF THE DRAWINGS

Further objects, features and advantages of the disclosed subject matter will become apparent from the following detailed description taken in conjunction with the accompanying figures showing an embodiment of the invention of which:

FIG. 1 is a diagram of checking the availability of a rental resource according to some embodiments of the disclosed subject matter.

FIG. 2 is a chart showing the data structure of a Pre-Computed Availability Data Set according to some embodiments of the disclosed subject matter.

FIG. 3 is a chart showing a Pre-Computed Availability Data Set filled with sample data according to some embodiments of the disclosed subject matter.

FIG. 4 is a diagram of checking the availability of a rental resource according to some embodiments of the disclosed subject matter.

FIG. 5 is a chart showing the data structure of a Rental Resource Data Set according to some embodiments of the disclosed subject matter.

FIG. 6 is a chart showing a Rental Resource Data Set filled with sample data and interacting with a Pre-Computed Availability Data Set that is filled with sample data according to some embodiments of the disclosed subject matter.

FIG. 7 is a chart showing a Rental Resource Data Set filled with sample data and interacting with a Pre-Computed Availability Data Set that is filled with sample data according to some embodiments of the disclosed subject matter.

FIG. 8 is a chart showing the data structure of a Pre-Computed Availability Data Set according to some embodiments of the disclosed subject matter.

FIG. 9 is a chart showing a Pre-Computed Availability Data Set filled with sample data according to some embodiments of the disclosed subject matter.

FIG. 10 is a chart showing the data structure of a Pre-Computed Availability Data Set according to some embodiments of the disclosed subject matter.

FIG. 11 is a chart showing a Pre-Computed Availability Data Set filled with sample data according to some embodiments of the disclosed subject matter.

FIG. 12 is a diagram of checking the price of a rental resource according to some embodiments of the disclosed subject matter.

FIG. 13 is a chart showing the data structure of a Pre-Computed Pricing Memory Area according to some embodiments of the disclosed subject matter.

FIG. 14 is a chart showing a Pre-Computed Pricing Memory Area filled with sample data according to some embodiments of the disclosed subject matter.

FIG. 15 is a chart showing a Rental Resource Data Set filled with sample data and interacting with a Pre-Computed Pricing Memory Area that is filled with sample data according to some embodiments of the disclosed subject matter.

### DETAILED DESCRIPTION OF THE DRAWINGS

The disclosed subject matter is directed to methods and systems for pre-computing the availability and price of a rental resource. By pre-computing either the availability or the permissible prices of a rental resource, a provider of such resources can control when these computationally intensive calculations take place. Specifically, the disclosed subject matter addresses the problem of real time calculations that limit the performance of such pricing or availability systems under high stress. The disclosed subject matter is effective in reducing response times when a potential consumer is attempting to reserve a rental resource because, in addition to storing the availability and pricing data in the traditional formats such as a very basic inventory for availability and in a rate plan data set for pricing, the disclosed subject matter pre-computes and stores these values in a format that is closer to what a consumer requests, in a stay-based format. In the context of the hotel industry, this stay-based format commonly involves requesting a room, the reservation to begin on a date certain, and to last for a specific duration. Traditional availability and pricing systems do not store the data in this way. Further, because the availability and price of a rental transaction can depend on more than just the start time and duration of the rental, any rules that might affect the availability and price can also be accounted for in this pre-computation.

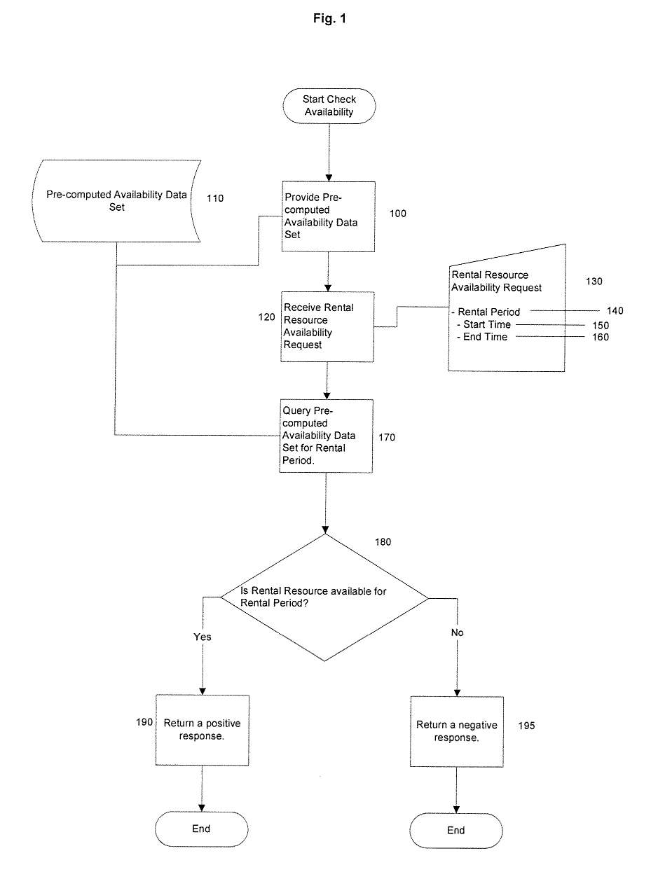

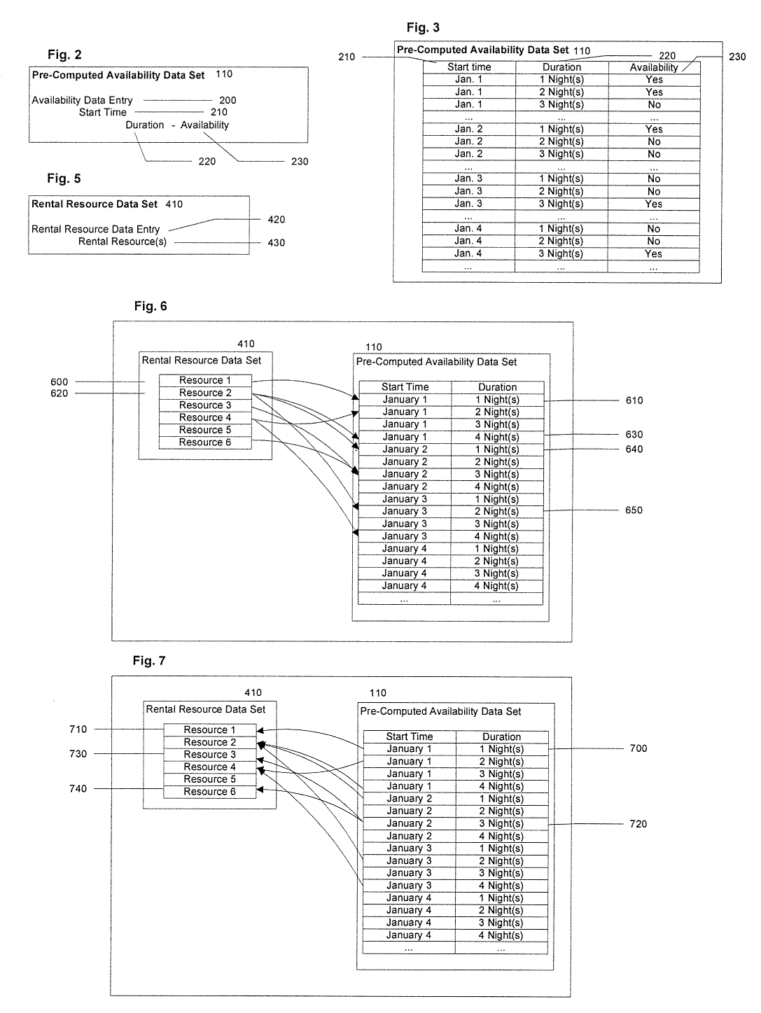

FIG. 1 represents an embodiment of the basic method of checking the availability of a rental resource. A rental resource can be a hotel room, a car, an airline seat, an appointment with a service provider, or any other product or service that is apportioned based on time. In the first step 100, a Pre-computed Availability Data Set 110 is provided. The Pre-Computed Availability Data Set 110 can be stored on a hard drive, a main frame, a flash drive, a diskette, or any other form of computer readable memory media. FIG. 2 shows the layout of an embodiment of the Pre-Computed Availability Data Set 110 wherein each Availability Data Entry 200 has a Start Time 210, a Duration 220, and an Availability 230. The Pre-Computed Availability Data Set 110 can be populated with Availability Data Entries 200 for each of at least one Start Times 210, wherein each Start Time 210 can have at least one Duration 220. FIG. 3 shows an embodiment of a Pre-Computed Availability Data Set 110 filled with example data. As can be seen in FIG. 3, each Start Time 210, represented by dates here, but which can be weeks, hours, quarter hours, etc., is associated with a multitude of Durations 220, represented by nights here, but which can also be weeks, hours, quarter hours, minutes, or any other time unit, which is merely a measure of time. In one embodiment, each Availability Data Entry 200, has a Start Time 210, Duration 220, and Availability 230 associated with it. The purpose of the Availability Data Entry 200 is to represent a specific rental period and can contain other data as is desired to be maintained.

In FIG. 1, after the Providing step 100, a Rental Resource Availability Request 130 is received in the Receiving step 120. The Rental Resource Availability Request contains at least a Start Time 150 and End Time 160 defining a Rental Period 140. A Rental Period 140 can represent a span of the time during which a rental resource is needed. The Start time 150 represents a first time at which a rental resource is needed and can be stored by the minute, hour, day, week, month, year, or any other time unit. The Rental Resource Availability Request can also contain merely a Start Time 150 and a duration, from which the End Time 160 can be calculated. After the Receiving step 120, the Pre-Computed Availability Data Set 110 is queried for the Rental Period 140 in the Querying step 170. In one embodiment, during the Querying step 170 the Pre-Computed Availability Data Set is queried for the Rental Period 140 and the Availability 230 of the Availability Data Entry 200 corresponding to the Rental Period 140 is returned. In the Determining step 180, if the Availability 230 is positive, then the process Returns a positive response 190, the response being some sort of indication of availability such as a printout, an electronic message, a single bit set to 1, or any other form of communicating with a user or system. In the Determining step 180, if the Availability 230 is not positive, then the process Returns a negative response 195.

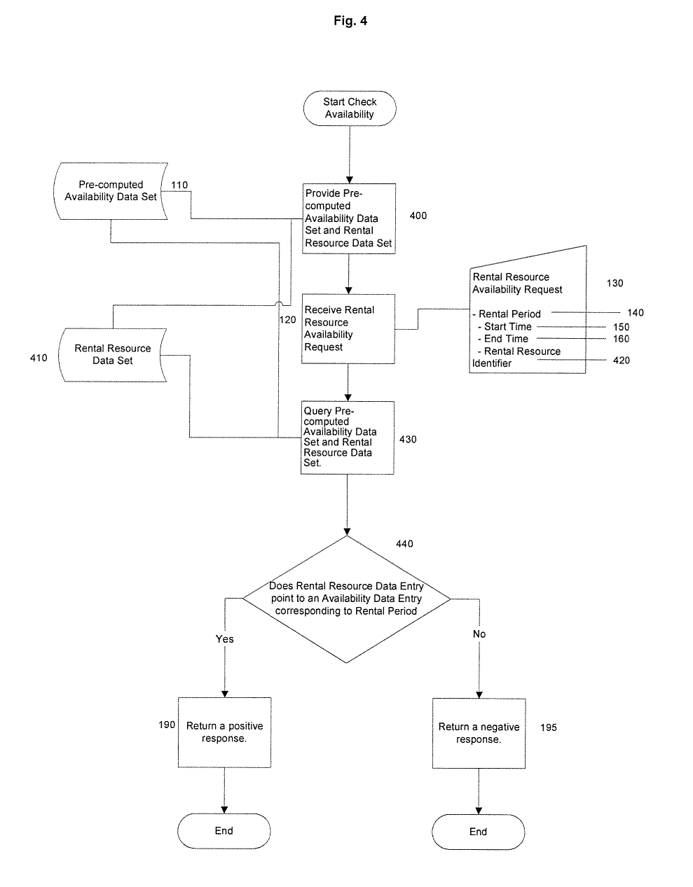

FIG. 4 shows an alternate embodiment of the method shown in FIG. 1. In FIG. 4, the Providing step 400 provides not only the Pre-Computed Availability Data Set 110, but the Rental Resource Data Set 410. The Rental Resource Data Set 410 can be stored on a hard drive, a main frame, a flash drive, a diskette, or any other form of computer readable memory media. FIG. 5 shows the layout of the Rental Resource Data Set 410. The Rental Resource Data Set 410 can contain a Rental Resource Data Entry 420 which can correspond to either one or a group of Rental Resources 430. FIG. 4 shows a further difference in this embodiment in that the Rental Resource Availability Request 130 also includes a Rental Resource Identifier 420 that corresponds with one or a group of rental resources. As seen in FIG. 6, the Rental Resource Data Entries 420 can reference or point to Availability Data Entries 200 in the Pre-Computed Availability Data Set 110. In this embodiment, if a Rental Resource Data Entry 420 references an Availability Data Entry 200, then the Rental Resource 430 associated with that Rental Resource Data Entry 420 is available for the rental period corresponding to the referenced Availability Data Entry 200. Multiple Availability Data Entries 200 can be referenced, indicating that the Rental Resource 430 is available for the rental periods associated with the Availability Data Entries 200 referenced. In FIG. 6, Resource 1 600 is only available on January 1 for one night 610. Resource 2 620, however, is available on January 1 for four nights 630, January 2 for one night 640, and January 3 for two nights 650. Using this structure, in one embodiment both the Pre-Computed Availability Data Set 110 and Rental Resource Data Set 410 are queried in the new Query Step 430. Further, in this embodiment, the Determining step 440 looks for whether the Rental Resource Data Entry 420 corresponding with the Rental Resource Identifier 420 references or points to the Availability Data Entry 200 corresponding to the desired Rental Period 130. If the Rental Resource Data Entry 420 does reference the correct Availability Data Entry 200, then a positive response is Returned 190. If the Rental Resource Data Entry 420 does not reference the correct Availability Data entry 200, then a negative response is Returned 195. In another embodiment, a Rental Resource Identifier 420 need not be provided and availability is determined based on whether any Rental Resource Data Entry 420 references the correct Availability Data Entry 200 corresponding with the Rental Period 140. In another embodiment, instead of Returning a positive response 190 or Returning a negative response 195, each Rental Resource 430 referencing the correct Availability Data Entry 200 corresponding to the Rental Period 140 can be identified to the user or system. This identification can take the form of a printout, an electronic message, a pointer to the actual Rental Resource Data Entries 420, or any other form of communication with a user or system.

FIG. 7 depicts a further embodiment, wherein the Availability Data Entries 200 reference or point to Rental Resource Data Entries 420 corresponding to Rental Resources 430 that are available for the Rental Periods 140 corresponding to the referencing Availability Data entries 200. Viewing the example in FIG. 7, the Availability Data Entry 200 corresponding to January 1 for one night 700 references Resource 1 710, which indicates that Resource 1 710 is available during that Rental Period. The Availability Data Entry 200 corresponding to January 2 for three nights 720 references Resources 3 730 and 6 740. Therefore, there are two Rental Resources 430 available during that Rental Period. In an embodiment where only a Start Time 150 and End Time 160 are included in the Rental Resource Availability Request 130, the embodiment shown in FIG. 7 would allow the Determining step 440 to simply take the result of a Query 430 of the Availability Data Entry 200 corresponding to the desired Rental Period 140 and consider whether that Availability Data Entry 200 references any Rental Resource Data Entries 420. In the event that the Availability Data Entry 200 does reference one or more Rental Resource Data Entries 420, then either a positive response can be Returned 190 or an indication of each of the Rental Resources 430 contained in the referenced Rental Resource Data Entries 420 can be returned.

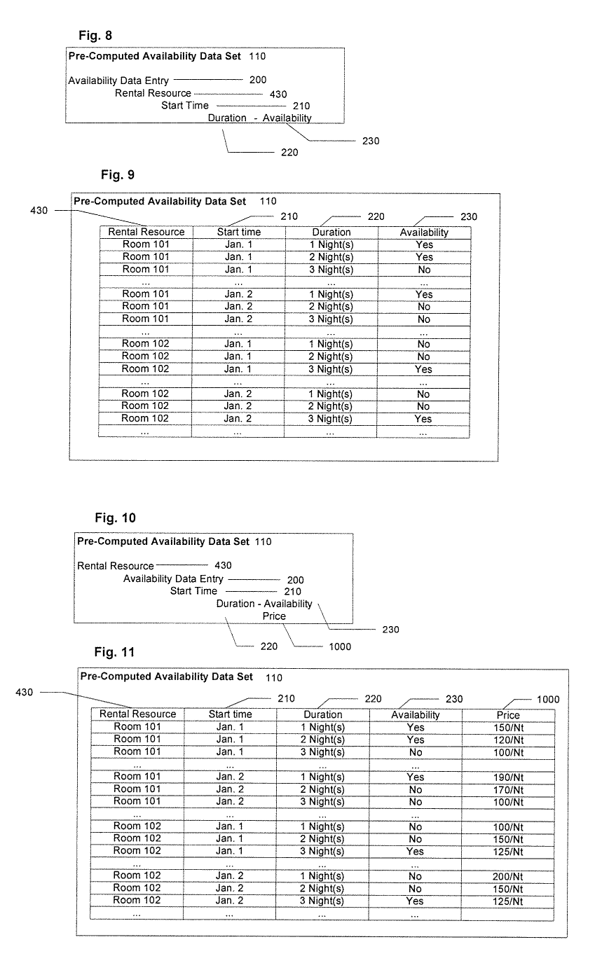

FIG. 8 depicts a further embodiment wherein the Pre-Computed Availability Data Set 110 stores an Availability Data Entry 200 with a Rental Resource 430, a Start Time 210, a Duration 220, and an Availability 230. The Pre-Computed Availability Data Set is populated with Availability Data Entries 200 for each of at least one Rental Resource 430, wherein each Rental Resource 430 can have at least one Start Time 210 and wherein each Start Time 210 can have at least one Duration 220. FIG. 9 shows an embodiment of a Pre-Computed Availability Data Set 110 filled with example data. As can be seen in FIG. 9, each Rental Resource 430, represented by rooms here but which can be cars, seats, etc., is associated with a multitude of Start Times 210, represented by dates here, but which can be weeks, hours, quarter hours, etc., which are associated with a multitude of Durations 220, represented by nights here, but which can also be weeks, hours, quarter hours, etc. Each of the Availability Data Entries 200 in this embodiment, therefore, has a Rental Resource 430, Start Time 210, Duration 220, and Availability 230 associated with it.

FIG. 10 depicts an embodiment, wherein the Pre-Computed Availability Data Set 110 stores an Availability Data Entry 200 with a Rental Resource 430, a Start Time 210, a Duration 220, an Availability 230, and a Price 1000. The Pre-Computed Availability Data Set 110 is populated with Availability Data Entries 200 for each of at least one Rental Resource 430, wherein each Rental Resource 430 can have at least one Start Time 210, wherein each Start Time 210 can have at least one Duration 220, and wherein each Duration 220 can have at least one Price 1000. FIG. 11 shows a Pre-Computed Availability Data Set 110 filled with example data in accordance with this embodiment.

In further embodiments, the Rental Resource 430 is an appointment with a service provider. A service provider can be a massage therapist, a physician, a service technician, a pilot, an attorney, an entertainer, a chef, a contract worker, or any other provider of services that are provisioned on a time basis.

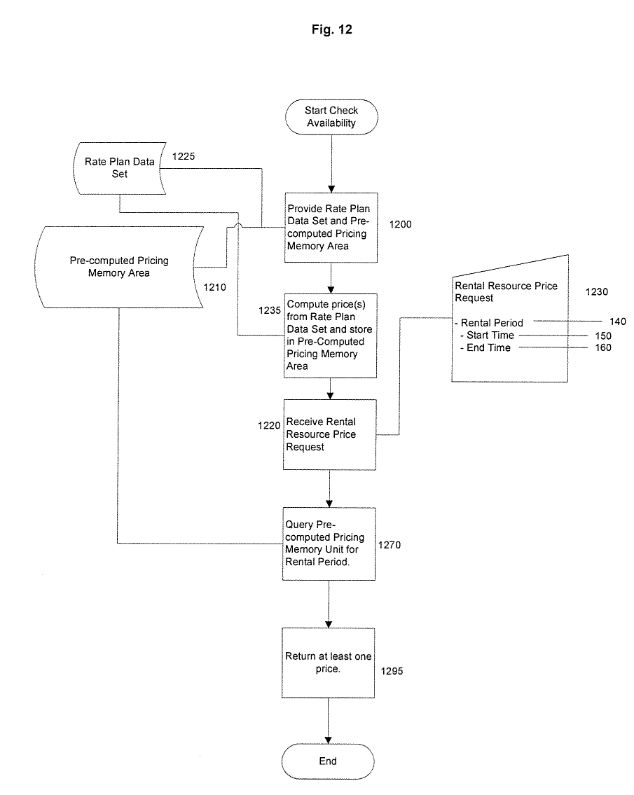

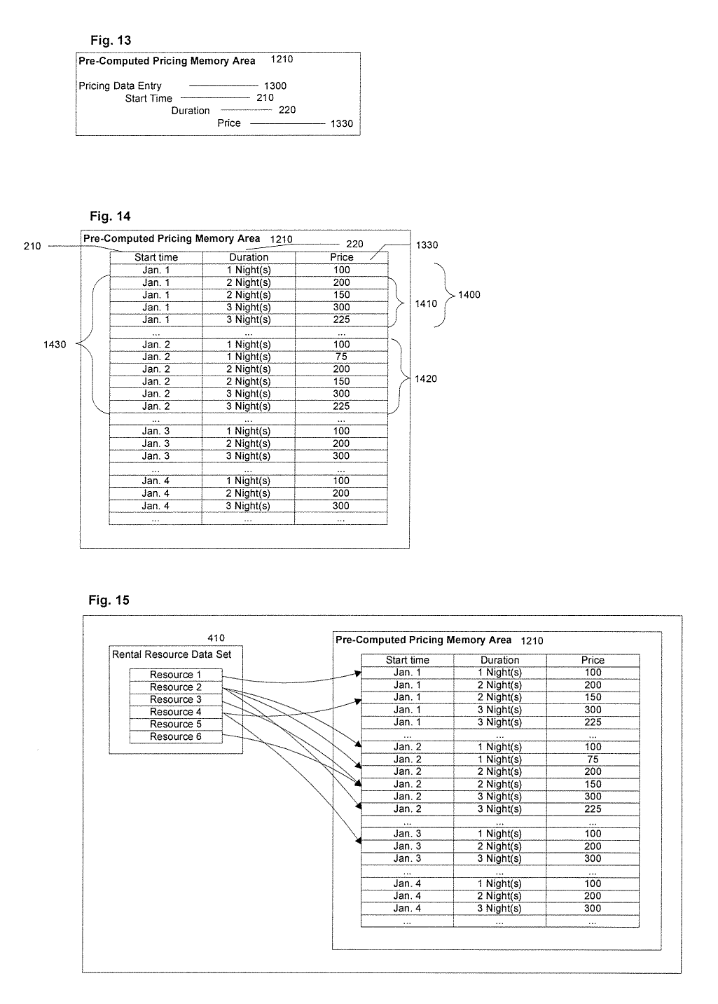

FIG. 12 represents an embodiment of the basic method of checking the price of a rental resource. A rental resource can be a hotel room, a car, an airline seat, or even an hour of a massage therapist's time. In the first step 1200, a Rate Plan Data Set 1225 and a Pre-computed Pricing Memory Area 1210 are provided. The Pre-Computed Memory Area 1210 can be stored on a hard drive, a main frame, a flash drive, a diskette, or any other form of computer readable memory media. FIG. 13 shows the layout of an embodiment of the Pre-Computed Pricing Memory Area 1210 wherein each Pricing Data Entry 1300 has a Start Time 210, a Duration 220, and a Price 1330. The Pre-Computed Pricing Memory Area 1210 can be populated with Pricing Data Entries 1300 for each of at least one Start Times 210, wherein each Start Time 210 can have at least one Duration 220, wherein each Duration 220 can have at least one Price 1330. FIG. 14 shows an embodiment of a Pre-Computed Pricing Memory Area 1210 filled with example data. As can be seen in FIG. 14, each Start Time 210, represented by dates here, but which can be represented by weeks, hours, quarter hours, or any other time unit, is associated with a multitude of Durations 220, represented by nights here, but which can also be weeks, hours, quarter hours, or any other time unit, and each Duration 220 can be associated with a multitude of Prices 1330. Each of the Pricing Data Entries 1300, therefore, has a Start Time 210, Duration 220, and Price 1330 associated with it. Also note in FIG. 14 that multiple prices can be available for a particular Start Time 210 and Duration 220. For instance, all Rental Periods 140 that span Jan. 2 1420 are available both at the standard rate of 100/Nt but also for 75/Nt. This affects Start Times 210 on Jan. 1, 1400 with Durations 220 of two and three nights 1410, as well as all Start Times 210 on Jan. 2, 1420. These differences in rates can arise from the Rate Plan Data Set 1225.

In FIG. 12, after the Providing step 1200, the Rate Plan Data Set 1225 is used in the Compute step 1235 to compute at least one price and store it in the Pre-Computed Pricing Memory Area 1210. In one embodiment, the Rate Plan Data Set 1225 is a collection of possible rate plans where each element of the Rate Plan Data Set 1225 has an associated ID, price, and set of requirements or restrictions on usage. These requirements or restrictions determine whether a specific rate plan is available for a Rental Period 140. The requirements and restrictions can take into consideration a multitude of factors which can include the Start Time 150 of the desired Rental Period 140, the day of the week on which the desired Rental Period 140 would begin, the days of the week that would be spanned by the desired Rental Period 140, the time that the Rental Resource Price Request 1230 is received, the identity of the person or system making the Rental Resource Price Request 1230, and the amount of time between making the Rental Resource Price Request 1230 and the desired Rental Period 140. A rate plan can take into consideration other factors depending on the type of resource that is being allocated. With regard to the identity of the person or system making the Rental Resource Price Request 1230, certain requesting entities, which can be a system, person, or organization capable of requesting a rental resource, can qualify to receive a certain rate plan. Qualifying merely means that the rate plan can be sold to that requesting entity.

In this embodiment, a Rental Resource Price Request 1230 containing a Start Time 150 and an End Time 160 defining at Rental Period 140 is Received 1220. This Rental Period 140 represents a time period during which the requester wishes to know a price. The Pre-Computed Pricing Memory Area 1210 is Queried 1270 for the Rental Period 140 stored in the Rental Resource Price Request 1230. A price stored in a Pricing Data Entry 1300 corresponding to the Rental Period 140 can be Returned 1295. The Returning step 1295 can communicate via a printout, an electronic message, a pointer to the actual Pricing Data Entries 1300, or any other form of communication with a user or system. In a further embodiment, the Return step 1295 can return either the lowest price resulting from the Query step 1270, or the Return step 1295 can return a multitude of prices resulting from the Query step 1270. In a further embodiment, the Rental Resource Price Request 1230 contains information concerning the qualification states of a requesting entity. These qualification states can be information concerning the requesting entity's identity, memberships, or any other status that can affect a Rate Plan. For example, a rate plan may only be available to requesting entities that are members of a special club such as a customer retention club, AAA (American Automobile Association) (trademark), AARP (trademark), or any other organization. Further, a qualification state can be based on whether a requesting entity is a corporation, corporate partner, student, or any other characteristic that can be used to restrict or permit access to a specific rate plan. In this embodiment, the qualification states are also used as factor in the Querying step 1270 so that only prices that correspond with the qualification states are returned.

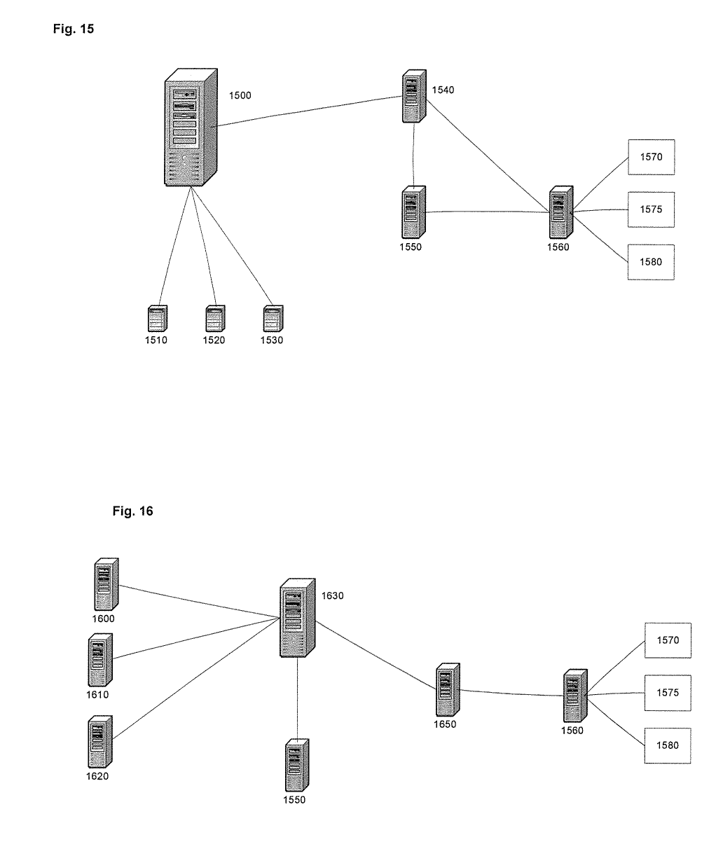

In a further embodiment, a Rental Resource Data Set 410, as depicted in FIG. 5, is provided in the Providing step 1200. The Rental Resource Data Set 410 can be stored on a hard drive, a main frame, a flash drive, a diskette, or any other form of computer readable memory media. The Rental Resource Data Set 410 contains Rental Resource Data Entries 420 corresponding to one or a group of Rental Resources 430. As seen in FIG. 15, each Rental Resource Data Entry 420 can reference, or point to, a Pricing Data Entry 1300 in the Pre-Computed Pricing Memory Area 1210 corresponding to Prices 1330 at which that Rental Resource 420 can be sold. A Rental Resource Data Entry 420 will typically point to at least one Pricing Data Entry 1300 for each potential Start Time 210 and Duration 220. However, it is not required that each Rental Resource Data Entry reference at least one Price 1330 for each Start Time 210 and Duration 220 because certain rental resources can have restrictions that would be best enforced in the context of price.

In other embodiments, a Rental Resource Price Request 1230 will contain, in addition to a Rental Period 140, data associated with a rental resource wherein to return the applicable prices, the Querying step 1270 need only consider which, if any, Pricing Data Entries 1300 that the Rental Resource Data Entry corresponding with the desired rental resource references or points to. In further embodiments, either all of the referenced Prices 1330, the lowest referenced Price 1330, or a plurality of referenced Prices 1330 can be return.

In other embodiments, Pricing Data Entries 1300 are grouped into pricing data groups. These pricing data groups can be based on lengths of stay, special sales, types of qualification states, or any other factor that would be appropriate to group Prices 1330 by. Further, these pricing data groups can be returned in addition to or instead of one or more specific individual Prices 1300 or Pricing Data Entries 1300.

FIG. 15 represents an embodiment of a current system for storing availability and pricing data that does not use the disclosed subject matter. A main server 1500 can store all the raw availability and pricing data about all rental resources. Many property management system computers 1510, 1520, and 1530 can communicate with the main server 1500 to provide and receive information about the availability and pricing of specific properties and rental resources. Queries from customers, websites, reservation systems and others 1570, 1575, and 1580 are received by the rates and availability server 1560. These queries can request the pricing and availability of rental resources. The rates and availability server 1560 can communicate with a property information server 1550 to receive and provide information about specific properties and rental resources. In the hotel industry, this information can include property location, weather, amenities, and service. In response to queries, the rates and availability server 1560 can query the transformation engine 1540 for the price and availability of a specific stay, which will typically not be in the same format as the main server 1500 stores such information. The transformation engine 1540 must query the main server 1500 for the raw availability and pricing data and calculate the availability and price based a format requested by a querying party. The transformation engine 1540 can then provide the stay specific availability and pricing to the rates and availability server 1560, which can then provide that information to the requesting entity 1570, 1575, and 1580.

FIG. 16 represents a layout of servers or databases according to embodiments of the disclosed subject matter. Prices can be stored in a rates engine 1600, availability data can be stored in an availability engine 1610 and other data can be stored in other servers 1620. The rates engine 1600, availability engine 1610, other servers 1620, and property information server 1550 are connected to a rates and availability computation engine 1630 that can extract the availability and pricing data from the availability engine 1600 and pricing engine 1610 respectively and pre-compute the availability and pricing of rental resources for a plurality of different rental periods beginning on a plurality of start dates. This pre-computation, especially of a price, can rely on data stored in the property information server 1550. The pre-computed availability and pricing data from the rates and availability computation engine 1630 can be stored in a rates and availability cache 1650. When queries are received by the rates and availability server 1560 from customers, websites, reservation systems and others 1570, 1575, and 1580, the rates and availability server 1560 can simply query the rates and availability cache 1650 for the data. In this embodiment, the complex availability and pricing data need not be calculated at the time of the query because the rates and availability computation engine 1630 can calculate the complex data on an ongoing basis and store it in the rates and availability cache 1650.

What is claimed is:

1. A method of checking for availability of a rental resource comprising:
providing a pre-computed availability data set for at least one rental resource comprising an availability data entry for each of a plurality of rental periods beginning on each of a plurality of start times and extending for each of a plurality of time units;
receiving a rental resource availability request comprising at least a first rental period comprising a start time and an end time;
querying said pre-computed availability data set for said first rental period;
determining, based on said querying, whether or not said at least one rental resource is available for said first rental period; and
returning a positive response when said at least one rental resource is available for said first rental period, otherwise returning a negative response.

2. The method of claim 1, further comprising providing a rental resource data set comprising at least one rental resource data entry representative of one or more of a plurality of rental resources, each rental resource data entry referencing each availability data entry in said pre-computed availability data set corresponding to a time period during which said one or more rental resources is available.

3. The method of claim 2, wherein said rental resource availability request further comprises data associated with one or more rental resources; and
said determining step comprises determining whether said rental resource data entry corresponding to said one or more rental resources references an availability data entry corresponding to said first rental period.

4. The method of claim 2, wherein said determining step comprises determining whether any rental resource data entry in said rental resource data set references an availability data entry corresponding to said first rental period.

5. The method of claim 4, further comprising the step of returning a response identifying each rental resource referencing an availability data entry corresponding to said first rental period.

6. The method of claim 1, further comprising providing a rental resource data set comprising at least one rental resource data entry representative of one or more of a plurality of rental resources, each rental resource data entry being referenced by each availability data entry in said pre-computed availability data set corresponding to a time period during which said one or more rental resources is available.

7. The method of claim 5, wherein said determining step comprises determining whether an availability data entry corresponding to said first rental period references any rental resource data entry in said rental resource data set.

8. The method of claim 7, further comprising the step of returning a response identifying each rental resource referenced by an availability data entry corresponding to said first rental period.

9. The method of claim 1, wherein said pre-computed availability data set comprises an availability data entry for each of at least one rental resource for each of a plurality of rental periods beginning on each of a plurality of start times and extending for each of a plurality of time units; and
said determining step comprising determining, based on said querying, whether or not any of said at least one rental resource is available for said first rental period.

10. The method of claim 1, wherein said at least one rental resource comprises a hotel room.

11. The method of claim 1, wherein said at least one rental resource comprises an appointment with a service provider.

12. The method of claim 1, wherein said time unit comprises a night.

13. The method of claim 1, wherein said at least one pre-computed availability data entry further comprises a at least one price for said at least one rental resource for each of said plurality of rental periods beginning on each of said plurality of start times and extending for each of said plurality of time units.

14. A method of checking the price of a rental resource comprising:
providing a rate plan data set comprising a plurality of rate plans and a pre-computed pricing memory area;
computing and storing in said pre-computed pricing memory area at least one pricing data entry comprising at least one price based on at least one of said rate plans for at least one rental resource for each of a plurality of rental periods beginning on each of a plurality of start times and extending for each of a plurality of time units;
receiving a rental resource price request comprising at least a first rental period comprising a start time and an end time;
querying said pre-computed pricing memory area for said at least one pricing data entry associated with said first rental period; and
returning said at least one price corresponding to said at least one rental resource for said first rental period.

15. The method of claim 14, wherein said returning step comprises returning a lowest price stored in said at least one pricing data entry associated with said at least one rental resource and said first rental period.

16. The method of claim 14, further comprising receiving information indicating the qualification states of the requesting entity to at least one of said rate plans, wherein said returning step comprises returning a lowest price the requested entity is qualified to receive.

17. The method of claim 14, wherein said returning step comprises returning a plurality of prices stored in said at least one pricing data entry associated with said at least one rental resource and said first rental period.

18. The method of claim 14, wherein said rate plan data set comprises at least one rate based on at least one factor selected from the group consisting of a unique start time corresponding to a rental period, a day of the week corresponding to said unique start time, a predetermined day of the week spanned by said rental period, time at which said rental resource price request is received, an identity of an individual making said rental resource price request, and the number of time units prior to said unique start time that said rental resource price request is made.

19. The method of claim 14, further comprising providing a rental resource data set comprising at least one rental resource data entry representative of one or more of a plurality of rental resources, each rental resource data entry referencing each pricing data entry in said pre-computed pricing memory area corresponding to a price for which said one or more rental resources is available.

20. The method of claim 19, wherein said rental resource pricing request further comprises data associated with one or more rental resources; and
said returning step comprises returning at least one price corresponding to any of said pricing data entries that are referenced by said rental resource data entry corresponding to said one or more rental resources.

21. The method of claim 14, wherein said pricing data set further comprises at least one pricing data group and said pricing data entries are stored in at least one data pricing group.

22. The method of claim 21, further comprising providing a rental resource data set comprising at least one rental resource data entry representative of one or more of a plurality of rental resources, each rental resource data entry referencing each pricing data group in said pricing data set corresponding to a pricing group for which said one or more rental resources is available.

23. The method of claim 14, wherein said at least one rental resource comprises a hotel room.

24. The method of claim 14, wherein said at least one rental resource comprises an appointment with a service provider.

25. The method of claim 14, wherein said time unit comprises a night.

26. A computer readable medium having a set of instructions operable to direct a processor to perform the steps of:
providing a pre-computed availability data set for at least one rental resource comprising an availability data entry for each of a plurality of rental periods beginning on each of a plurality of start times and extending for each of a plurality of time units;
receiving a rental resource availability request comprising at least a first rental period comprising a start time and an end time;
querying said pre-computed availability data set for said first rental period;
determining, based on said querying, whether or not said at least one rental resource is available for said first rental period; and
returning a positive response when said at least one rental resource is available for said first rental period.

27. The computer readable medium of claim 26, wherein said set of instructions is further operable to perform the step of providing a rental resource data set comprising at least one rental resource data entry representative of one or more of a plurality of rental resources, each rental resource data entry referencing each availability data entry in said pre-computed availability data set corresponding to a time period during which said one or more rental resources is available.

28. The computer readable medium of claim 27, wherein said rental resource availability request further comprises data associated with one or more rental resources; and
said determining step comprises determining whether said rental resource data entry corresponding to said one or more rental resources references an availability data entry corresponding to said first rental period.

29. The computer readable medium of claim 27, wherein said determining step comprises determining whether any rental resource data entry in said rental resource data set references an availability data entry corresponding to said first rental period.

30. The computer readable medium of claim 29, wherein said set of instructions is further operable to perform the step of returning a response reference each rental resource referencing an availability data entry corresponding to said first rental period.

31. The computer readable medium of claim 26, wherein said set of instructions is further operable to perform the step of providing a rental resource data set comprising at least one rental resource data entry representative of one or more of a plurality of rental resources, each rental resource data entry being referenced by each availability data entry in said pre-computed availability data set corresponding to a time period during which said one or more rental resources is available.

32. The computer readable medium of claim 30, wherein said determining step comprises determining whether an availability data entry corresponding to said first rental period references any rental resource data entry in said rental resource data set.

33. The computer readable medium of claim 32, wherein said set of instructions is further operable to perform the step of returning a response referencing each rental resource referenced by an availability data entry corresponding to said first rental period.

34. The computer readable medium of claim 26, wherein said pre-computed availability data set comprises an availability data entry for each of at least one rental resource for each of a plurality of rental periods beginning on each of a plurality of start times and extending for each of a plurality of time units; and
said determining step comprising determining, based on said querying, whether or not any of said at least one rental resource is available for said first rental period.

35. The computer readable medium of claim 26, wherein said at least one rental resource comprises a hotel room.

36. The computer readable medium of claim 26, wherein said at least one rental resource comprises an appointment with a service provider.

37. The computer readable medium of claim 26, wherein said time unit comprises a night.

38. The computer readable medium of claim 26, wherein said pre-computed availability data set further comprises a pricing data entry comprising at least one price for said at least one rental resource for each of said plurality of rental periods beginning on each of said plurality of start times and extending for each of said plurality of time units.

39. A computer readable medium having a set of instructions operable to direct a processor to perform the steps of:
providing a rate plan data set comprising a plurality of rate plans and a pre-computed pricing memory area;
computing and storing in said pre-computed pricing memory area at least one pricing data entry comprising at least one price based on at least one of said rate plans for at least one rental resource for each of a plurality of rental periods beginning on each of a plurality of start times and extending for each of a plurality of time units;
receiving a rental resource price request comprising at least a first rental period comprising a start time and an end time;
querying said pre-computed pricing memory area for said at least one pricing data entry associated with said first rental period; and
returning said at least one price corresponding to said at least one rental resource for said first rental period.

40. The computer readable medium of claim 39, wherein said returning step comprises returning a lowest price stored in said at least one pricing data entry associated with said at least one rental resource aid said first rental period.

41. The computer readable medium of claim 39, wherein said set of instructions is further operable to perform the step of receiving information indicating the qualification states of the requesting entity to at least one of said rate plans, wherein said returning step comprises returning a lowest price the requested entity is qualified to receive.

42. The computer readable medium of claim 39, wherein said returning step comprises returning a plurality of prices stored in said at least one pricing data entry associated with said at least one rental resource and said first rental period.

43. The computer readable medium of claim 39, wherein said rate plan data set comprises at least one rate based on at least one factor selected from the group consisting of a unique start time corresponding to a rental period, a day of the week corresponding to said unique start time, a predetermined day of the week spanned by said rental period, time at which said rental resource price request is received, an identity of an individual making said rental resource price request, and the number of time units prior to said unique start time that said rental resource price request is made.

44. The computer readable medium of claim 39, wherein said set of instructions is further operable to perform the step of providing a rental resource data set comprising at least one rental resource data entry representative of one or more of a plurality of rental resources, each rental resource data entry referencing each pricing data entry in said pre-computed pricing memory area corresponding to a price for which said one or more rental resources is available.

45. The computer readable medium of claim 44, wherein said rental resource pricing request further comprises data associated with one or more rental resources; and
said returning step comprises returning at least one price corresponding to any of said pricing data entries that are referenced by said rental resource data entry corresponding to said one or more rental resources.

46. The computer readable medium of claim 39, wherein said pricing data set further comprises at least one pricing data group and said pricing data entries are stored in at least one data pricing group.

47. The computer readable medium of claim 46, wherein said set of instructions is further operable to perform the step of providing a rental resource data set comprising at least one rental resource data entry representative of one or more of a plurality of rental resources, each rental resource data entry referencing each pricing data group in said pricing data set corresponding to a pricing group for which said one or more rental resources is available.

48. The computer readable medium of claim 39, wherein said at least one rental resource comprises a hotel room.

49. The computer readable medium of claim 39, wherein said at least one rental resource comprises an appointment with a service provider.

50. The computer readable medium of claim 39, wherein said time unit comprises a night.
